(19) United States
(12) Patent Application Publication
(10) Pub. No.: US 2013/0002714 A1
(43) Pub. Date: Jan. 3, 2013

(54) DISPLAY CONTROL APPARATUS AND METHOD FOR CONTROLLING DISPLAY

(75) Inventor: Kyota SAITO, Yokohama-shi (JP)

(73) Assignee: CANON KABUSHIKI KAISHA, Tokyo (JP)

(21) Appl. No.: 13/527,416

(22) Filed: Jun. 19, 2012

(30) Foreign Application Priority Data
Jun. 29, 2011 (JP) 2011-144630

(51) Int. Cl. G09G 5/00

(52) U.S. Cl. 345/629

(57) ABSTRACT

In providing a user interface displayed in a tabbed format, a display control apparatus displays information effectively on a limited display screen, particularly in a tab display area. To effectively use the tab display area, a currently selected tab is displayed smaller than non-selected tabs that may be selected later.

### BACKGROUND OF THE INVENTION

1. Field of the Invention

The present invention relates to a display control apparatus and a method for controlling display.

2. Description of the Related Art

In a known user interface, tabs using a metaphor of file folders are arranged so that, by selecting a tab, a user can switch between screen displays in an electronic apparatus.

Typical examples of such user interfaces include web browsers. In a web browser, the user switches between multiple pages by clicking on tabs on the screen using a mouse or a touch panel.

In such user interfaces utilizing tabs, various schemes are implemented because the screen size and hence the size and the number of tabs available are limited.

For example, Japanese Patent Application Laid-Open No. 2000-172398 discusses a technique for using a screen area effectively. According to the technique, in a currently selected tab, an icon and a character-string label representing the contents of the tab are displayed, while non-selected tabs are displayed as small tabs in which only an icon is displayed.

Japanese Patent Application Laid-Open No. 2008-107865 also discusses a technique in which not only a currently selected tab but also adjacent tabs are displayed as large tabs.

In the conventional example, information for the selected tab and the adjacent tabs is sufficiently provided, but, unfortunately, the amount of information for the other tabs, which are displayed as small tabs, is not sufficient. Thus, sometimes the user cannot accurately identify which tab indicates the contents that the user wants to select next.

Furthermore, in selecting a tab using the mouse or the touch panel, the user may select a wrong tab because the size of the tab that the user wants to select next is small.

### SUMMARY OF THE INVENTION

The present invention is directed to displaying the contents of tabs which may be selected next in a readily understandable manner, while allowing a tab-selecting operation using a mouse, a touch panel, or other input devices to be performed reliably.

According to an aspect of the present invention, a display control apparatus includes a selection unit configured to select a tab from among a plurality of tabs that are displayed on a display screen, and a display control unit configured to control display of the display screen in response to a tab being selected by the selection unit. In response to the tab being selected by the selection unit, the display control unit causes the selected tab to be displayed smaller than before the tab is selected so that the selected tab is displayed smaller than non-selected tabs of the plurality of tabs.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a digital camera according to an exemplary embodiment of the present invention.

FIG. 2 illustrates the configuration of a setting menu in the digital camera according to the exemplary embodiment of FIG. 1.

FIG. 3 illustrates a menu display screen according to the exemplary embodiment of FIG. 1.

FIG. 4 is a flowchart illustrating processing performed when the menu display screen according to the exemplary embodiment shown in FIG. 3 is displayed.

FIGS. 5A, 5B and 5C illustrate screen transitions in the menu display screen according to the exemplary embodiment shown in FIG. 3.

### DESCRIPTION OF THE EMBODIMENTS

Various exemplary embodiments, features, and aspects of the invention will be described in detail below with reference to the drawings.

In the following description, the present invention is applied to a digital camera. However, the present invention is not limited to only this application, but may be applied to any display apparatuses having display screens and to any apparatuses for controlling display apparatuses.

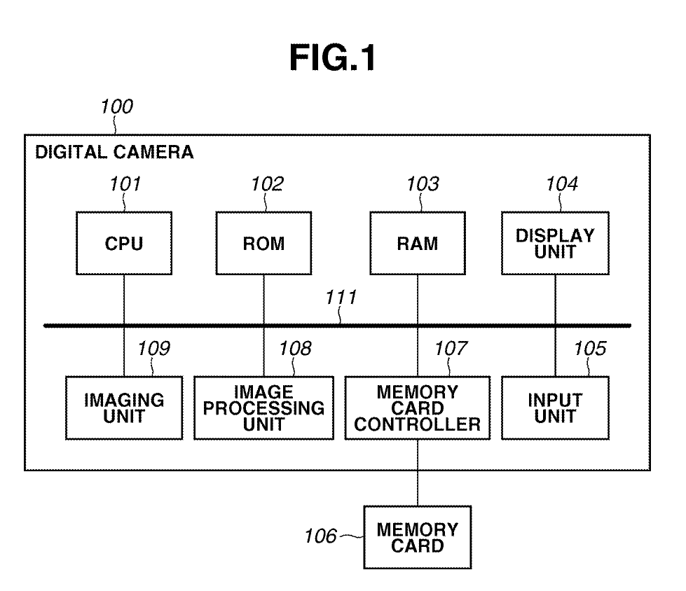

FIG. 1 is a block diagram illustrating a configuration of a digital camera according to an exemplary embodiment of the present invention.

A digital camera 100 includes a central processing unit (CPU) 101, a read only memory (ROM) 102, a random access memory (RAM) 103, a display unit 104, an input unit 105, a memory card 106, a memory card controller 107, an image processing unit 108, and an imaging unit 109. These components are connected to each other via an internal bus 111.

The CPU 101 is an arithmetic processing apparatus for controlling an operation of the digital camera 100. In response to an instruction input by a user via the input unit 105, the CPU 101 also executes various programs to control, for example, display of the display unit 104. The ROM 102 stores images and programs for, for example, computer startup processing, basic input-output processing, and processing according to the present invention, which will be described below. The CPU 101 reads the programs from the ROM 102, and controls each component and performs arithmetic processing based on the read programs, thereby performing various kinds of operations.

The RAM 103 is used as a work area for the CPU 101. The display unit 104 uses a liquid crystal display (LCD) panel for displaying a graphic user interface. Images and display items, which will be described below, are displayed on the display unit 104.

At the input unit 105, an instruction from the user is received. The present exemplary embodiment employs a touch sensor. The LCD panel (the display unit 104) with the touch sensor attached thereto is used as a touch panel. The user can operate the digital camera 100 by inputting a variety of instructions by touching the input unit 105 (the touch sensor).

Images captured by the digital camera 100 are recorded on the memory card 106. The memory card 106 is detachably mounted in the digital camera 100. When mounted into a mounting unit (not illustrated), the memory card 106 is connected to the memory card controller 107. The memory card controller 107 reads data from and writes data into the connected memory card 106.

The imaging unit 109 captures an image in response to an instruction for image-capturing entered at the input unit 105. The image data captured and generated by the imaging unit 109 is transmitted to the image processing unit 108 via the internal bus 111. The image processing unit 108 performs various kinds of image processing and compressing and encoding processing on the image data to generate an image file.

The generated image file is transmitted to the memory card controller 107 to be recorded on the memory card 106. The imaging unit 109 can capture both moving images and still images. The user can select, using the input unit 105, whether to capture a moving image or a still image.

When the user inputs an instruction to display a setting menu screen using the input unit 105, the setting menu screen is displayed on the display unit 104.

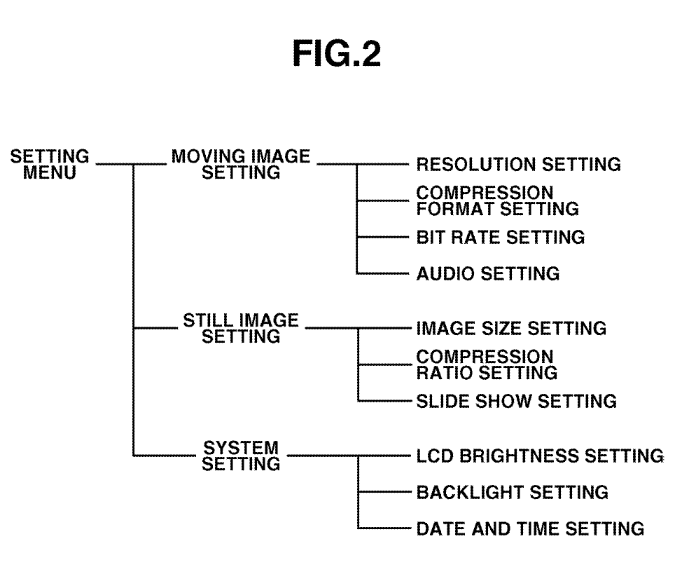

A setting menu of the digital camera 100 will be described below with reference to FIG. 2.

The digital camera 100 according to the present exemplary embodiment provides the setting menu for making various settings. The setting menu includes setting items as illustrated in FIG. 2.

Since the setting menu includes many setting items, the items may be arranged in a hierarchical structure, in which grouping is performed so that related items are in the same group, for easy selection by the user. In one example, the setting items are divided into three groups: a moving image setting for moving image capturing, a still image setting for still image capturing, and a system setting for a system of the digital camera.

In one embodiment, the moving image setting may include a resolution setting, a compression format setting, a bit rate setting, and an audio setting. The still image setting may include an image size setting, a compression ratio setting, and a slide show setting. The system setting may include an LCD brightness setting, a backlight setting, and a date and time setting.

Upon a user's selection of a setting group, namely, the moving image setting, the still image setting or the system setting, in the setting menu, the setting items included in the selected setting group are displayed. Then, selecting one of the displayed setting items results in the display of a setting screen for the selected setting item, allowing the user to make settings for that setting item.

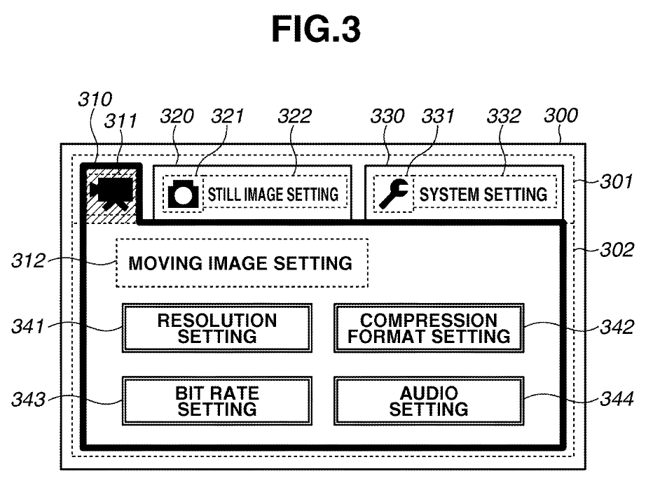

The setting menu screen will be described with reference to FIG. 3.

The setting menu screen is displayed in a tabbed format on a display screen 300 of the display unit 104. In a tab display area 301 on the display screen 300, tabs representing the respective groups, that is, the moving image setting, the still image setting, and the system setting, are displayed. Displayed in a detail display area 302 are the setting items that are included in the group corresponding to a selected one of the tabs displayed in the tab display area 301. In FIG. 3, the tab indicating the moving image setting is selected.

In the tab display area 301, a moving image setting tab 310, a still image setting tab 320, and a system setting tab 330 are displayed. In the moving image setting tab 310, a moving image setting icon 311, which is an icon representing the moving image setting, is displayed. In the still image setting tab 320, a still image setting icon 321, which is an icon indicating the still image setting, and still image setting characters 322, which indicate the still image setting, are displayed. In the system setting tab 330, a system setting icon 331, which is an icon indicating the system setting, and system setting characters 332, which indicate the system setting, are displayed.

When the user touches the tab 310, 320, or 330 on the display screen 300 with his or her finger or a pen, the input unit 105 senses the touching, and the tab corresponding to the touched position is selected.

In FIG. 3, the moving image setting tab 310 is selected. The selected moving image setting tab 310 is highlighted in a different color from the non-selected tabs 320 and 330 so as to allow the user to recognize the selection of the moving image setting tab 310. The selected tab is displayed in a different color in the present exemplary embodiment, but may also be displayed with a different shape, shading, or using other distinguishing visual features. Any display method may be employed so long as the selected tab is displayed in a display form different from that of the non-selected tabs, and the user can recognize that the tab displayed in that different form is the selected tab.

Since the moving image setting is currently selected, the setting items 341 to 344 indicating the resolution setting, the compression format setting, the bit rate setting, and the audio setting, respectively, included in the moving image setting group are displayed in the detail display area 302. Characters or text for “Moving image setting” 312 are also displayed in the detail display area 302. When the user touches one of the setting items 341 to 344, the detail display area 302 switches to a display screen corresponding to the setting item located at the touched position, allowing the user to make settings for that item.

The selected moving image setting tab 310 is displayed in a smaller size than the non-selected tabs 320 and 330. In the tab display area 301 in which the tabs are displayed side by side in the horizontal direction, the selected moving image setting tab 310 is smaller in the horizontal direction (i.e., in the tab width) than the other non-selected tabs 320 and 330. In the moving image setting tab 310 having a small display area, only the icon is displayed, and no descriptive characters are displayed.

In contrast, the icon and corresponding descriptive characters are both displayed in the non-selected still image setting tab 320 and the system setting tab 330. Since the user has selected the moving image setting tab 310 by himself or herself, and the setting items related to the moving image setting are displayed in the detail display area 302, the user can recognize which tab is being selected even if both the characters and the icon are not displayed in the tab 310.

Thus, in the present exemplary embodiment, the tab 310 is made smaller such that only the icon 311 is displayed therein. Although no characters are displayed in the selected tab 310, the characters 312 representing the selected moving image setting may be displayed in the detail display area 302 as illustrated in FIG. 3. Then, even if no characters are displayed in the selected tab 310, the characters 312 displayed in the detail display area 302 allow the user to recognize which tab is currently selected.

The non-selected tabs (the still image setting tab 320 and the system setting tab 330 illustrated in FIG. 3) may be selected next. Furthermore, the tabs are the only areas that can indicate the contents of the non-selected tabs. Hence, the non-selected tabs are displayed to have a greater width than the currently selected tab so that the icon and the characters can be both displayed therein to let the user easily recognize which tabs are the non-selected tabs.

As set forth above, to effectively use the limited tab display area 301, the selected tab is displayed in a reduced size, while the non-selected tabs are displayed as large tabs in the present exemplary embodiment. More information is thus displayed in the non-selected tabs than in the selected tab. This enables the user to easily identify the contents of the tabs.

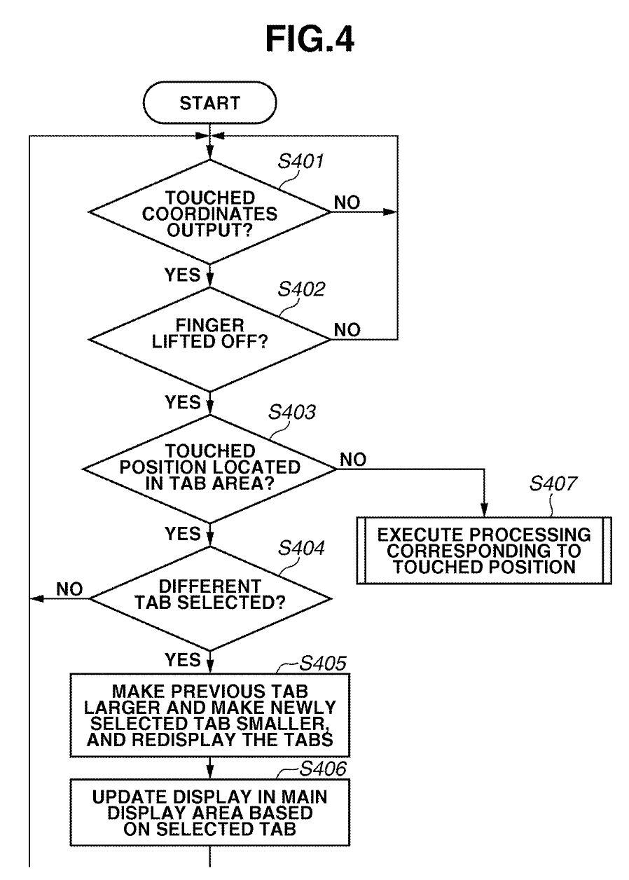

A processing flow performed when the setting menu is displayed in the digital camera 100 will be described below with reference to FIG. 4. The CPU 101 executes the processing flow by controlling the components of the digital camera 100 and performing arithmetic processing based on programs read from the ROM 102.

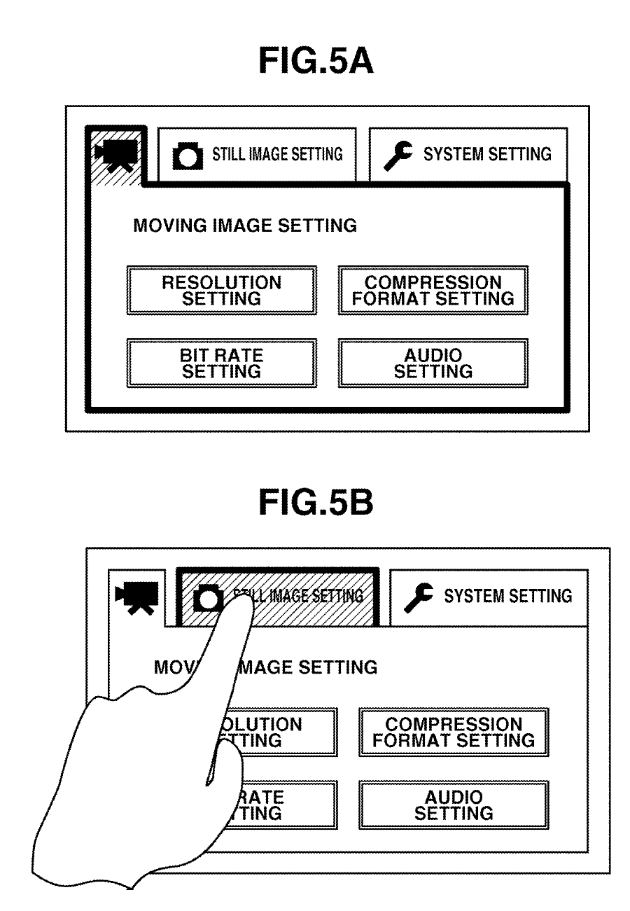

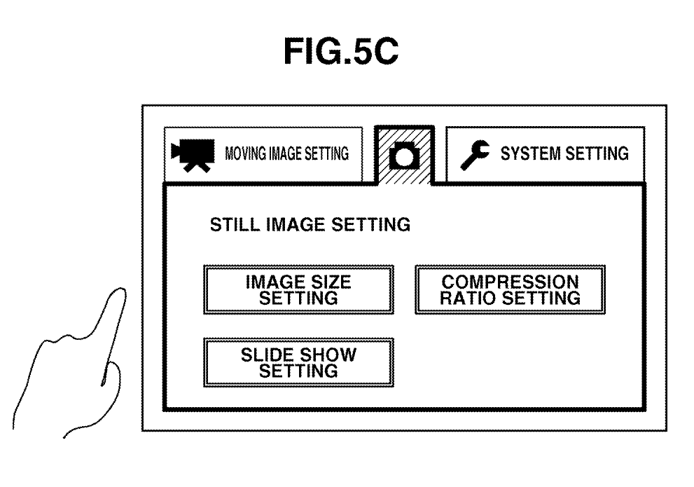

The processing flow is executed when a setting menu such as that illustrated in FIG. 5A is displayed.

During the display of the setting menu, in step S401, the touch sensor of the input unit 105 monitors whether the user has touched the touch panel. If the user has touched the touch panel with his or her finger, a pen, or the like, the input unit 105 senses the touching and outputs coordinates of the touched position. Thus, in step S401, a determination is made whether the coordinates of the touched position (the touched coordinates) have been output.

If the touched coordinates have been output (YES in step S401), the processing proceeds to step S402. If not (NO in step S401), then in step S401, the touch sensor continues to monitor whether the touched coordinates have been output. Then, in step S402, a determination is made whether the output of the touched coordinates has stopped, that is, whether the user has performed a “touch-up” operation in which the user has terminated contact with the touch panel by lifting his or her finger, pen, or the like off the touch panel.

While the touched coordinates are being output and the user is touching the touch panel, the icon displayed in the position corresponding to the touched coordinates may be highlighted, for example, the color thereof may be changed, as illustrated in FIG. 5B. In the present exemplary embodiment, a selection made by touching is accepted when the user performs “touch-up”. Therefore, the determination processing in step S402 continues to be performed until the user performs “touch-up”.

If the output of the touched coordinates has stopped, and thus a determination is made that the user has performed “touch-up” (YES in step S402), the user selection made by touching is determined, causing the processing to proceed to step S403. The touched coordinates last output indicate the touched position where the determined selection was made.

The last-output touched coordinates indicate the touched position touched by the user immediately before the user lifted his or her finger or pen. Thus, in step S403, a determination is made of whether the touched position is within the tab area or other areas. If the touched position is located in an area other than the tab area (NO in step S403), then in step S407, processing corresponding to the touched position is executed.

For example, if the touched position on the setting menu screen illustrated in FIG. 3 is in one of the setting items 341 to 344, the setting item corresponding to the touched position is selected, resulting in switching to a display screen corresponding to the selected setting item. If the touched position is in the tab area (YES in step S403), processing in step S404 and following steps is executed.

The tab touched by the user immediately before “touch-up” (that is, lifting his or her finger or pen off the touch panel) is newly selected. Therefore, in step S404, a determination is made whether the newly selected tab is the one that has already been selected or a tab other than the already selected tab.

If the newly selected tab is the already selected tab (NO in step S404), the processing returns to step S401 without updating the display of the setting menu, and waits until the user touches the touch panel again to output the touched coordinates. If the newly selected tab is different from the already selected tab (YES in step S404), then in steps S405 and S406, the display of the setting menu is updated because a different tab item, that is, a different setting group, has been selected.

First, in step S405, sizes of the tabs are changed. Specifically, the newly selected tab is made smaller, while the previously selected tab is made larger. In this manner, the respective sizes of the tabs are changed. Then, in the newly selected tab, only an icon representing the setting group corresponding to that tab is displayed. In each of the non-selected tabs, an icon and characters indicating the setting group are displayed.

Next, in step S406, the display of the detail display area 302 is changed. Characters corresponding to the setting group indicated by the newly selected tab, and icons representing the setting items included in the newly selected setting group are displayed in the detail display area 302.

To be specific, in the setting menu where the moving image setting group has already been selected, if the user who is touching the still image setting tab terminates the touching as illustrated in FIG. 5B, the display switches from the screen illustrated in FIG. 5B to the screen illustrated in FIG. 5C.

In FIG. 5C, in which the still image setting group is selected, only the still image setting icon is displayed in the still image setting tab. In the moving image setting tab and the system setting tab, the respective icons and characters corresponding to those tabs are displayed. Since no characters are displayed in the still image setting tab, the still image setting characters, and the icons representing the setting items included in the still image setting group are displayed in the detail display area 302.

When this display update is completed, the processing returns to step S401, where touching by the user is monitored again.

As described above, since the tab size is changed in response to selection of a tab, any necessary information can be presented to the user even if the display area is small. Furthermore, considering that a tab that is not currently selected is likely to be selected next, the area of tabs that may be selected next is made larger. This enables the user to easily select a tab even if the display unit is small, for example.

Moreover, since no characters are displayed in the selected tab, a larger area can be allocated to the other tabs, permitting larger characters to be displayed in the other areas. At this time, the size of the characters to be displayed may be changed in response to changes in the tab area size so as to display the characters of the largest possible size. A non-selected tab is likely to be selected next. Thus, displaying characters of larger size in the non-selected tabs enables the user to easily select the next tab.

In the foregoing exemplary embodiments, in response to “touch-up”, the selection at the touched position is determined, causing the update of the display of the setting menu screen. Alternatively, a display update such as illustrated in steps S405 and S406 may also be performed while the user is touching the touch panel, instead of being performed at the time of “touch-up”.

In the foregoing exemplary embodiments, the tab size is changed in width (the horizontal direction). However, if the display area has enough space in height (the vertical direction), the height of the selected tab may also be changed.

In the foregoing exemplary embodiments, the present invention is applied to a touch panel. However, the present invention is also applicable to display of a setting menu in a tabbed display format, as illustrated in FIG. 3, in a system where a display apparatus, a control apparatus, and a mouse are connected. In that case, the control apparatus causes the display apparatus to display the setting menu. The control apparatus then determines a tab selected by the user based on position input information provided from the mouse, and performs display update processing such as described above according to the selection of the tab.

The present invention has been described in detail with reference to the exemplary embodiments. However, the present invention is not limited to the particular embodiments described herein, but encompasses various changes and modifications which fall within the scope of the principles of the invention. The foregoing exemplary embodiments may be partially combined with each other in an appropriate manner.

In the foregoing exemplary embodiments, the LCD display apparatus with the touch panel has been described as an example. However, the user may select a tab by operating a mouse. The present invention is also applicable to display apparatuses other than those using the LCD.

In the description in the foregoing exemplary embodiments, the user selects a tab from among a plurality of tabs displayed on the display screen. However, the display method described above is not limited to tabs, but may be applied to cases in which, instead of tabs, a plurality of display items, such as icons, are displayed side by side. Basically, the present invention is applicable to display items if processing similar to that employed to display the tabs is performed. In that case, in response to a selection of a display item, the selected display item is displayed in a smaller size than non-selected display items. As in the case of tabs, information about the selected display item is displayed in a detail display area. The detail display area may be controlled so as to move according to the position of the display item, instead of being displayed in a fixed position.

Aspects of the present invention can also be realized by a computer of a system or apparatus (or devices such as a CPU or MPU) that reads out and executes a program recorded on a memory device (computer-readable medium) to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-144630 filed Jun. 29, 2011, which is hereby incorporated by reference in its entirety.

What is claimed is:

1. A display control apparatus comprising:
a selection unit configured to select a tab from among a plurality of tabs that are displayed on a display screen; and
a display control unit configured to control display of the display screen in response to a tab being selected by the selection unit,
wherein, in response to the tab being selected by the selection unit, the display control unit causes the selected tab to be displayed smaller than before the tab is selected so that the selected tab is displayed smaller than non-selected tabs of the plurality of tabs.

2. The display control apparatus according to claim 1, wherein the display control unit causes more information to be displayed in the non-selected tabs of the plurality of tabs than in the selected tab.

3. The display control apparatus according to claim 1, wherein the display control unit causes characters corresponding to the respective non-selected tabs of the plurality of tabs to be displayed in the non-selected tabs, and causes characters corresponding to the selected tab not to be displayed in the selected tab.

4. The display control apparatus according to claim 1, wherein the display control unit causes an icon and characters to be displayed in the non-selected tabs, and causes an icon to be displayed in the selected tab without characters displayed therein.

5. The display control apparatus according to claim 1, wherein the display screen includes a tab display area in which the plurality of tabs is displayed, and a detail display area in which a display related to the selected tab of the plurality of tabs is provided.

6. The display control apparatus according to claim 5, wherein the display control unit causes characters corresponding to the selected tab not to be displayed in the selected tab, but to be displayed in the detail display area.

7. The display control apparatus according to claim 1, wherein, in response to a non-selection of the selected tab, the display control unit causes the non-selected tab to be displayed larger than when selected.

8. The display control apparatus according to claim 1, wherein, in response to the tab being selected by the selection unit, the display control unit causes a previously selected tab to be displayed larger on the display screen than when the previously selected tab was selected.

9. The display control apparatus according to claim 1, wherein, in response to determination of the selection of the tab by the selection unit, the display control unit causes the selected tab to be displayed smaller than the non-selected tabs.

10. The display control apparatus according to claim 1, wherein the display control unit causes the tab selected by the selection unit to be displayed smaller than the non-selected tabs and to be displayed as a highlighted tab in a different display format from the non-selected tabs.

11. The display control apparatus according to claim 1, wherein the selection unit selects one of the plurality of tabs.

12. The display control apparatus according to claim 1, wherein the selection unit allows a user to select a tab displayed on the display screen using a touch panel.

13. The display control apparatus according to claim 1, wherein the selection unit allows a user to select a tab displayed on the display screen using a mouse.

14. A method for controlling display of a display apparatus, the method comprising:
displaying a plurality of tabs on the display apparatus; and
in response to a tab being selected from among the plurality of tabs displayed on the display apparatus, causing the selected tab to be displayed smaller than non-selected tabs of the plurality of tabs.

15. A non-transitory computer-readable storage medium storing a program that causes a computer to execute the method according to claim 14.

16. A display control apparatus comprising:
a selection unit configured to select an item from among a plurality of items displayed on a display screen; and
a display control unit configured to control display of the display screen in response to an item being selected by the selection unit,
wherein, in response to the item being selected by the selection unit, the display control unit causes the selected item to be displayed smaller than before the item is selected so that the selected item is displayed smaller than non-selected items of the plurality of items.

17. A method for controlling display of a display apparatus, the method comprising:
displaying a plurality of items on the display apparatus; and
in response to an item being selected from among the plurality of items displayed on the display apparatus, causing the selected item to be displayed smaller than non-selected items of the plurality of items.

18. A non-transitory computer-readable storage medium storing a program that causes a computer to execute the method according to claim 17.
